(19) United States
(12) Patent Application Publication
(10) Pub. No.: US 2024/0330208 A1
(43) Pub. Date: Oct. 3, 2024

(54) METHOD AND SYSTEM FOR SWITCHING INPUT DEVICE

(71) Applicant: ASUSTeK COMPUTER INC., Taipei City (TW)

(72) Inventors: Yi-Chi Lai, Taipei City (TW); Li-Yuan Huang, Taipei City (TW); Jing-Kai Huang, Taipei City (TW)

(73) Assignee: ASUSTeK COMPUTER INC., Taipei City (TW)

(21) Appl. No.: 18/505,117

(22) Filed: Nov. 9, 2023

(30) Foreign Application Priority Data
Mar. 29, 2023 (TW) 112111910

(51) Int. Cl. G06F 13/10; G06F 13/40

(52) U.S. Cl. CPC G06F 13/102; G06F 13/4022; G06F 13/4068

(57) ABSTRACT

A method and a system for switching an input device are disclosed. The method is adapted to the system for switching the input device including a main control device and a slave device. The main control device is connected to an input device and detects input information of the input device. The main control device detects a transmission protocol between the main control device and the slave device. Whether a control target device of the input device is the slave device is determined by the main control device. When the control target device of the input device is the slave device, the main control device converts the input information into a transmission packet conforming to the transmission protocol. The transmission packet is transmitted from the main control device to the slave device. The slave device parses the transmission packet to obtain the input information to perform an input operation according to the input information.

### CROSS-REFERENCE TO RELATED APPLICATION

This application claims the priority benefit of Taiwan application serial no. 112111910, filed on Mar. 29, 2023. The entirety of the above-mentioned patent application is hereby incorporated by reference herein and made a part of this specification.

### BACKGROUND

### Technical Field

The disclosure relates to an input control system, and more particularly, to a method and a system for switching an input device.

### Description of Related Art

Generally speaking, when a user wants to control multiple computer devices through a set of input devices, it is necessary to direct input commands of the input device to a certain target device that the user wants to control through various means. For example, the user may need to plug and unplug the input device frequently to connect the input device to the target device, but this is quite troublesome for the user. In addition, the user needs to purchase specific hardware devices, such as a keyboard/video/mouse switch (KVM switch) or a mouse and a keyboard that support cross-device control functions, etc. However, the use of the hardware devices is not only required to consider the compatibility of hardware and software, but also may become a problem in portability. In addition, when the computer devices support different operating systems, it is easy to encounter the dilemma that the cross-device control functions of the input device may not be compatible with heterogeneous environments.

### SUMMARY

The disclosure provides a method for switching an input device adapted to a system for switching the input device including a main control device and a slave device. The method includes the following. The main control device is connected to the input device and detects input information of the input device. The main control device detects a transmission protocol between the main control device and the slave device. Whether a control target device of the input device is the slave device is determined by the main control device. When the control target device of the input device is the slave device, the main control device converts the input information into a transmission packet conforming to the transmission protocol. The transmission packet is transmitted from the main control device to the slave device. The slave device parses the transmission packet to obtain the input information to perform an input operation according to the input information.

The disclosure further provides a system for switching an input device, including an input device, a slave device, and a main control device. The main control device is connected to the input device and detects input information of the input device. The main control device detects a transmission protocol between the main control device and the slave device, and determines whether a control target device of the input device is the slave device. When the control target device of the input device is the slave device, the main control device converts the input information into a transmission packet conforming to the transmission protocol, and transmits the transmission packet to the slave device. The slave device parses the transmission packet to obtain the input information to perform an input operation according to the input information.

Based on the above, in the disclosure, the input device is connected to the main control device, and the main control device will detect the transmission protocol between main control device and the slave device. When the control target device of the input device is the slave device, the main control device may convert the input information of the input device into the transmission packet conforming to the transmission protocol, and transmit the transmission packet to the slave device. Afterwards, the slave device may perform the input operation according to the input information in the transmission packet. Therefore, in the disclosure, the switching input of the input device among the computer devices supporting different operating systems nay be achieved, thereby greatly improving the convenience and application flexibility of switching the input device for controlling in a cross-platform environment.

### BRIEF DESCRIPTION OF THE DRAWINGS

FIG. 1 is a schematic view of a system for switching an input device according to an embodiment of the disclosure.

FIG. 2 is a schematic view of a method for switching an input device according to an embodiment of the disclosure.

FIG. 3 is a schematic view of converting input information into a transmission packet conforming to a transmission protocol according to an embodiment of the disclosure.

FIG. 4 is a schematic view of converting input information into a transmission packet conforming to a transmission protocol according to an embodiment of the disclosure.

FIG. 5 is a schematic view of converting input information into a transmission packet conforming to a transmission protocol according to an embodiment of the disclosure.

FIG. 6 is a schematic view of identifying a control target device of an input device according to an embodiment of the disclosure.

FIG. 7 is a flowchart of a method for switching an input device according to an embodiment of the disclosure.

### DETAILED DESCRIPTION OF DISCLOSED EMBODIMENTS

Reference will now be made in detail to the exemplary embodiments of the disclosure, and examples of the exemplary embodiments are illustrated in the accompanying drawings. Whenever possible, the same reference numerals are used in the drawings and descriptions to indicate the same or similar parts. The embodiments are only a part of the disclosure and do not disclose all possible implementations of the disclosure. More precisely, the embodiments are merely examples of the device and the method.

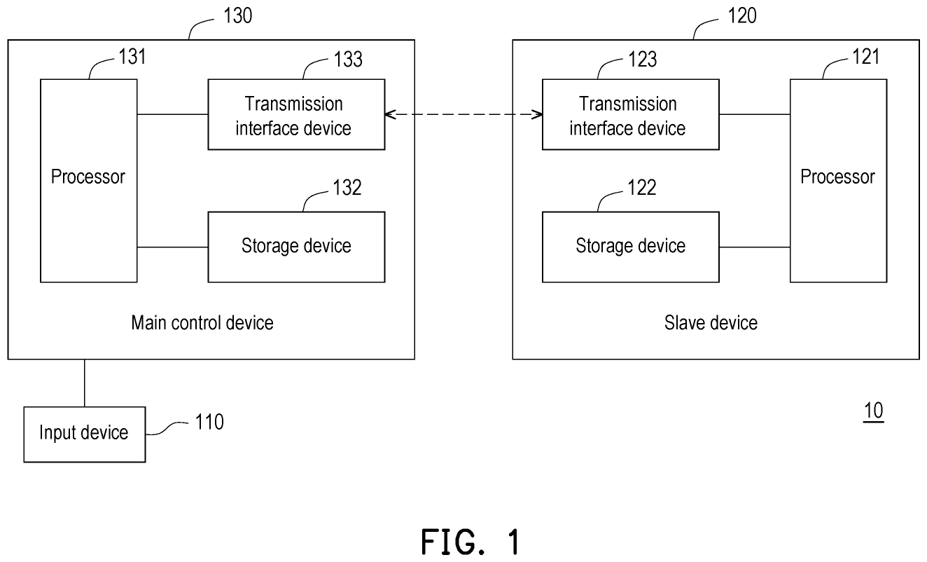

Referring to FIG. 1, a system 10 for switching an input device includes an input device 110, a slave device 120, and a main control device 130. This embodiment is described by taking one main control device 130 corresponding to one slave device 120 as an example. However, the disclosure does not limit the number of slave devices under the main control device 130.

In some embodiments, the input device 110 may be an electronic peripheral device that may generate input information according to a manipulation behavior of a user such as a keyboard, a mouse, a touch input device (such as a stylus or a touch panel), or a joystick.

In some embodiments, the slave device 120 and the main control device 130 are computer devices such as smartphones, tablet computers, game consoles, notebook computers, desktop computers, or industrial computers. However, the disclosure is not limited thereto. In addition, in some embodiments, the slave device 120 may further be implemented as a robot device, such as a robot arm system.

The main control device 130 may include a processor 131, a storage device 132, and a transmission interface device 133. The slave device 120 may include a processor 121, a storage device 122, and a transmission interface device 123.

The storage device 132 and the storage device 122 are configured to store data such as files, documents, commands, program codes, or software modules, which may be, for example, any type of fixed or removable random access memory (RAM), read-only memory (ROM), flash memory, hard disk, or other similar devices, integrated circuits or a combination thereof.

The processor 131 and the processor 121 are, for example, a central processing unit (CPU), an application processor (AP), other programmable general-purpose or special-purpose microprocessors, a digital signal processor (DSP), a programmable controller, an application specific integrated circuit (ASIC), a programmable logic device (PLD), a graphics processing unit (GPU), other similar devices, or a combinations of these devices.

The processor 131 may execute the program codes, the software modules, the commands, etc. recorded in the storage device 132, and the processor 121 may execute the program codes, the software modules, the commands, etc. recorded in the storage device 122, so as to implement a method for switching the input device in the embodiment of the disclosure. The software modules may be broadly interpreted as commands, command sets, codes, program codes, programs, operating systems, applications, software packages, threads, procedures, functions, etc.

The transmission interface device 133 and the transmission interface device 123 may be used for communication transmission, which may support a wired transmission protocol or a wireless transmission protocol. Specifically, the transmission interface device 133 and the transmission interface device 123 may respectively include a transceiver. The transceiver may transmit and receive signals in a wireless or wired manner. The transceiver may further perform operations such as low noise amplification, impedance matching, frequency mixing, up or down frequency conversion, filtering, or amplification.

In some embodiments, the transmission interface device 133 and the transmission interface device 123 support the same transmission protocol, so that a connection between the main control device 130 and the slave device 120 may be established. The main control device 130 may provide the input information of the input device 110 to the slave device 120 through the connection. For example, both the transmission interface device 133 and the transmission interface device 123 may support a Bluetooth transmission protocol. In addition, both the transmission interface device 133 and the transmission interface device 123 may support a TCP (Transmission Control Protocol) transmission protocol. Moreover, both the transmission interface device 133 and the transmission interface device 123 may support a differential interface transmission protocol, a USB transmission protocol, etc.

In some embodiments, the main control device 130 may be connected to the input device 110. The disclosure does not limit a connection method between the main control device 130 and the input device 110, and the input device 110 may be connected to the main control device 130 through a wired or wireless connection interface. For example, the input device 110 may be connected to the main control device 130 through a USB interface. In addition, the input device 110 may be connected to the main control device 130 through a Bluetooth interface.

In some embodiments, the main control device 130 may detect and retrieve the input information of the input device 110. The input information is, for example, a movement amount of the mouse, a movement track sensed by the touch input device, pressing information of a key of the keyboard, or a shaking direction of the joystick, etc. However, the disclosure is not limited thereto.

In some embodiments, the main control device 130 may detect a transmission protocol between the main control device 130 and the slave device 120. That is to say, the main control device 130 may detect the transmission protocol supported by the transmission interface device 123 of the slave device 120. In some embodiments, the main control device 130 may detects that the slave device 120 also supports the TCP transmission protocol through a local area network by using a multicast domain name system (mDNS). In addition, in some embodiments, the main control device 130 may detect that the slave device 120 also supports the Bluetooth transmission protocol by using a Bluetooth broadcast packet in the Bluetooth transmission protocol. In some embodiments, the main control device 130 may detect that the slave device 120 also supports the USB transmission protocol by using access detection of the USB transmission protocol. Moreover, in some embodiments, the main control device 130 may detect the transmission protocol supported by the slave device 120 by using a connection of a specific driving program. It should be noted that in some embodiments, the main control device 130 may detect that the slave device 120 supports one or more sets of transmission protocols at the same time. That is, the slave device 120 may establish a corresponding connection with the main control device 130 through the one or more sets of transmission protocols.

In different embodiments, the main control device 130 and the slave device 120 may run the same or different operating systems. For example, both the main control device 130 and the slave device 120 may run a Windows operating system. In addition, the main control device 130 may run the Windows operating system, but the slave device 120 may run an Android operating system.

In some embodiments, the main control device 130 may determine whether a control target device of the input device 110 is the slave device 120. In other words, the main control device 130 may determine that the current control target device of the input device 110 is the slave device 120, the main control device 130, or other slave devices that may communicate with the main control device 130. The control target device represents a transmission destination of the input information of the input device 110.

In some embodiments, when the control target device of the input device 110 is the slave device 120, the main control device 130 converts the input information into a transmission packet conforming to the transmission protocol. Afterwards, the main control device 130 may transmit the transmission packet to the slave device 120 through the connection between the transmission interface device 133 and the transmission interface device 123. Therefore, the slave device 120 may parse the transmission packet to obtain the input information, so as to perform an input operation according to the input information. The input operation may be a mouse input operation, a keyboard input operation, a joystick input operation, a touch input operation, etc. The mouse input operation may include a mouse movement operation, a mouse drag operation, a mouse click operation, etc. The keyboard input operation may include a character input operation, a control key input operation, a function key input operation, a hot key input operation, etc. It should be noted that, in some embodiments, when the slave device 120 may establish the corresponding connection with the main control device 130 through multiple sets of transmission protocols, the main control device 130 converts the input information into the transmission packet conforming to one of the transmission protocols. As a result, the user may control the slave device 120 and the main control device 130 through the input device 110.

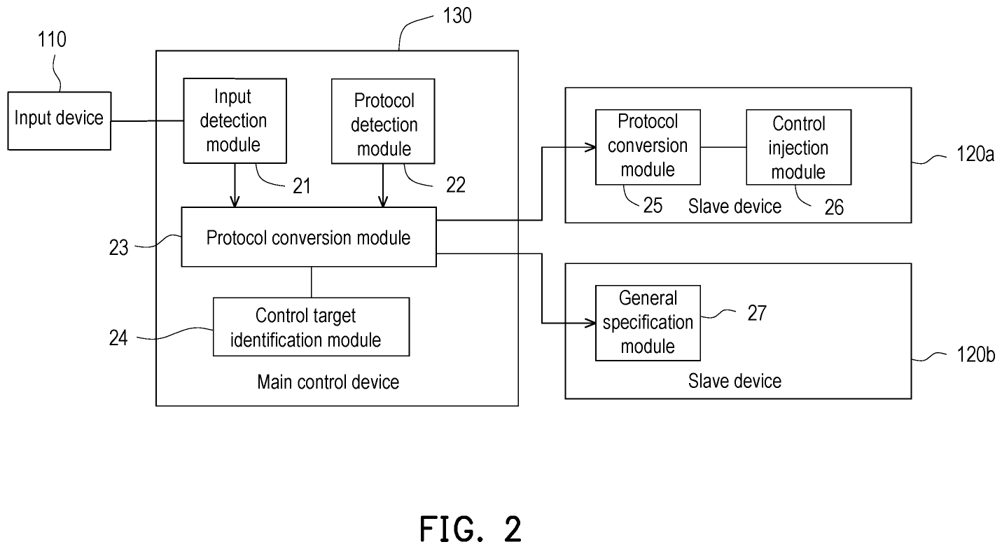

Referring to FIG. 2, the main control device 130 may include an input detection module 21, a protocol detection module 22, a protocol conversion module 23, and a control target identification module 24. The input detection module 21, the protocol detection module 22, the protocol conversion module 23, and the control target identification module 24 may be implemented by hardware, software, firmware, or a related combination thereof.

The input detection module 21 may detect the input information of the input device 110. The input detection module 21 may retrieve the input information of the input device 110 by means of driver layer signal hook, firmware signal hook, system layer event retrieving, electronic device signal analysis, etc.

In some embodiments, the main control device 130 may use a system event hook program to retrieve an input event of the input device 110, and the input event includes the input information of the input device 110. More specifically, in some embodiments, the input detection module 21 may be implemented by the system event hook program, which may monitor various events in the operating system at an operating system layer and retrieve the input event of the input device 110.

In some embodiments, the main control device 130 may retrieve the input information of the input device 110 through the driving program. More specifically, in some embodiments, the input detection module 21 may be implemented by a filter driver. The filter driver may intercept and modify communication between the driving program of the input device 110 and the operating system, so that the input information of the input device 110 may be monitored and intercepted.

The protocol detection module 22 may detect a transmission protocol supported by a slave device 120a and a slave device 120b. A method in which the protocol detection module 22 detects the transmission protocol supported by the slave device 120a and the slave device 120b has been described above. Therefore, the same details will not be repeated in the following. It should be noted that in some embodiments, the main control device 130 may determine whether the transmission protocol supports a general specification. The general specification is, for example, a human interface devices (HID) specification.

In some embodiments, the control target identification module 24 may confirm that the control target device is the main control device 130, the slave device 120a, or the slave device 120b. When the control target device is the main control device 130, the main control device 130 may directly perform the input operation according to the input information of the input device 110 without generating the transmission packet including the input information. When the control target device is the slave device 120a or the slave device 120b, the main control device 130 converts the input information of the input device 110 into the transmission packet, so that the slave device 120a or the slave device 120b may obtain the input information of the input device 110 by receiving the transmission packet.

In some embodiments, the protocol conversion module 23 may be configured to convert the input information of the input device 110 into the transmission packet. More specifically, the protocol detection module 22 may inform the protocol conversion module 23 of the transmission protocol supported by the slave device 120a and the slave device 120b. In addition, the control target identification module 24 may notify the protocol conversion module 23 of an identification result of the control target identification module 24. Therefore, when the control target device is the slave device 120a or the slave device 120b, the protocol conversion module 23 may convert the input information of the input device 110 into the transmission packet according to the transmission protocol supported by the slave device 120a or the slave device 120b. The protocol conversion module 23 may convert the input information retrieved by the input detection module 21 into the input information conforming to a specific data format, and then package the input information conforming to the specific data format into the transmission packet conforming to the transmission protocol. In different embodiments, the specific data format may be a human interface devices (HID) format, a json format, or other types of data description formats.

It should be noted that the protocol conversion module 23 may determine a conversion data format of the input information according to whether the transmission protocol conforms to the general specification. The general specification is, for example, the HID specification.

Specifically, in some embodiments, when the transmission protocol supported by the slave device 120a as the control target device does not conform to the general specification (for example, the TCP transmission protocol supported by the slave device 120a does not conform to the HID specification), the protocol conversion module 23 of the main control device 130 converts the input information conforming to a first data format into the input information conforming to a second data format, so as to generate the transmission packet conforming to the transmission protocol. The first data format is determined according to the transmission protocol between the input device 110 and the main control device 130, and the second data format is determined according to the transmission protocol supported by the slave device 120a. Correspondingly, a protocol conversion module 25 of the slave device 120a converts the input information conforming to the second data format into the input information conforming to a third data format, and performs the input operation according to the input information conforming to the third data format. Here, a control injection module 26 of the slave device 120a may inject the input information conforming to the third data format into the operating system, so that the slave device 120a performs the input operation.

In addition, in some embodiments, when the transmission protocol supported by the slave device 120b as the control target device conforms to the general specification (for example, the Bluetooth transmission protocol supported by the slave device 120b conforms to the HID specification), the protocol conversion module 23 of the main control device 130 may convert the input information into a data format conforming to the general specification to generate the transmission packet. Afterwards, the protocol conversion module 23 of the main control device 130 may input the transmission packet to the driving program supporting the general specification. Specifically, the protocol conversion module 23 may establish the driving program supporting the general specification to input the transmission packet to the driving program. The driving program may be implemented as a HID device driving program of a Bluetooth HID protocol. Correspondingly, the slave device 120b may obtain the transmission packet according to another driving program, and perform the input operation according to the input information conforming to the general specification in the transmission packet. For example, a general specification module 27 of the slave device 120b may be implemented as a HID host driving program of the Bluetooth HID protocol.

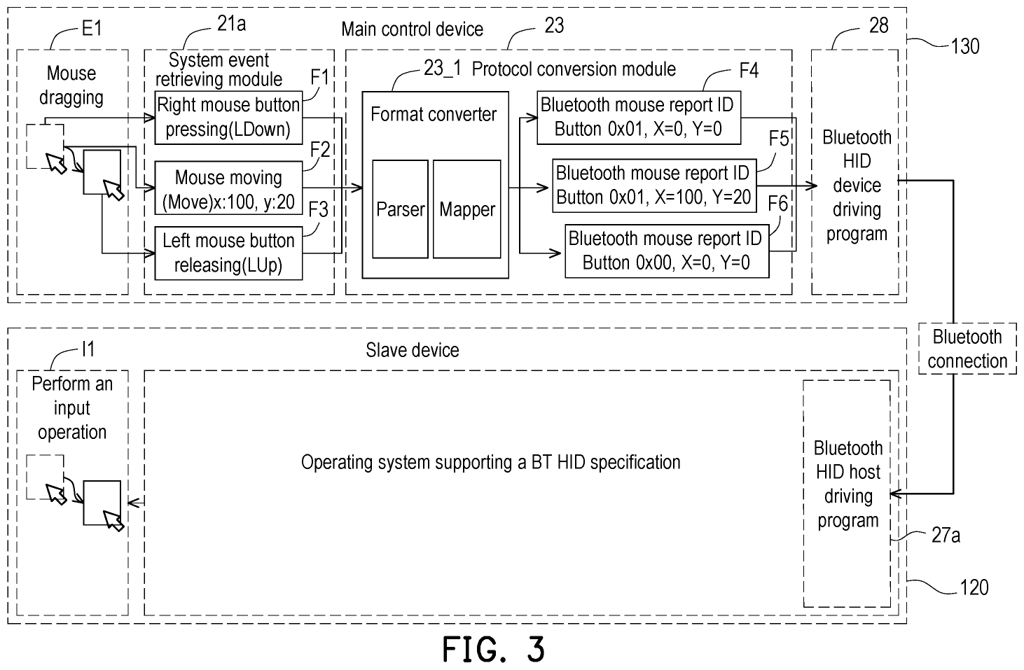

Referring to FIG. 3, in this embodiment, it is assumed that the main control device 130 runs the Windows operating system, and the slave device 120 runs the Android operating system. In addition, the main control device 130 and the slave device 120 may establish the connection through the Bluetooth transmission protocol. When the user controls the mouse (that is, the input device 110) to perform a drag operation, a system event retrieving module 21a (that is, the system event hook program) of the main control device 130 may detect an input event E1 of the mouse to obtain input information F1 to F3. A data format of the input information F1 to F3 is determined according to a device motion set defined by the operating system. A format converter 23_1 of the protocol conversion module 23 may convert the input information F1 to F3 into input information F4 to F6 conforming to the HID specification. A parser in the format converter 23_1 may interpret parameters of the input information F1 to F3, and a mapper in the format converter 23_1 may map parameter interpretation results of the input information F1 to F3 into a standard format of a HID report, so as to generate the input information F4 to F6 conforming to the HID specification.

Afterwards, the protocol conversion module 23 may inject the input information F4 to F6 conforming to the HID specification into a virtual Bluetooth HID device driving program 28. Specifically, when it is determined to convert the input information F1 to F3 into the input information F4 to F6 conforming to the HID specification, the main control device 130 may also generate the virtual Bluetooth HID device driving program 28 at the same time. The input information F4 to F6 conforming to the HID specification are packaged into a bluetooth transmission packet to be transmitted to the slave device 120. A Bluetooth HID host driving program 27a of the slave device 120 will automatically identify and process the Bluetooth transmission packet, so that the slave device 120 may perform an input operation I1. In this embodiment, the slave device 120 may perform the mouse drag operation to achieve functions such as file dragging.

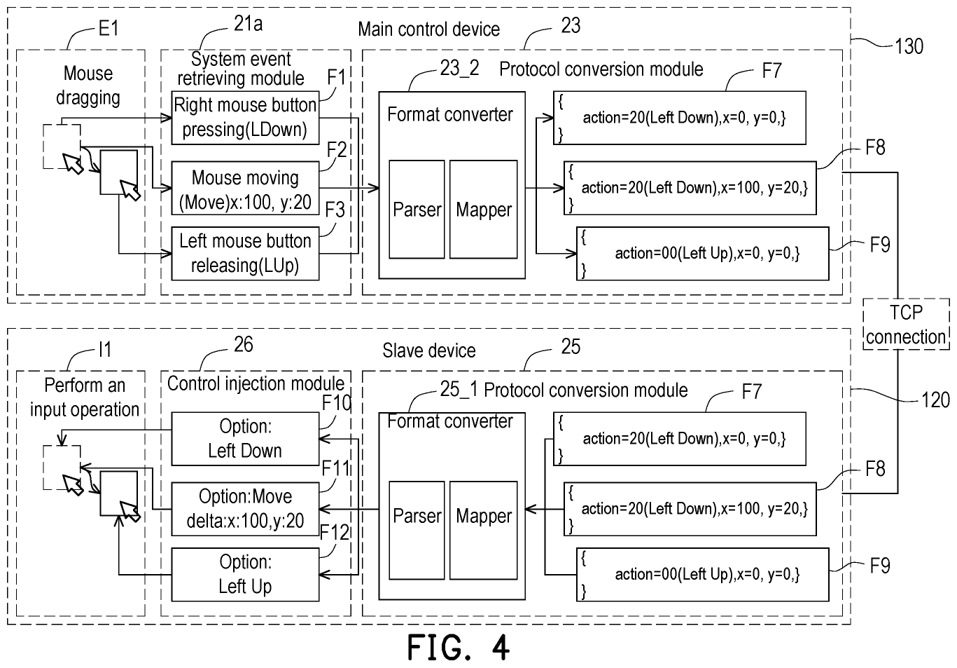

Referring to FIG. 4, in this embodiment, it is assumed that the main control device 130 runs the Windows operating system, and the slave device 120 runs the Windows operating system. In addition, the main control device 130 and the slave device 120 may establish the connection through the TCP protocol. When the user controls the mouse (that is, the input device 110) to perform the drag operation, the system event retrieving module 21a of the main control device 130 may detect the input event E1 of the mouse to obtain the input information F1 to F3. The data format of the input information F1 to F3 is determined according to the device motion set defined by the operating system. A format converter 23_2 of the protocol conversion module 23 may convert the input information F1 to F3 into input information F7 to F9 conforming to the json format. A parser in the format converter 23_2 may interpret the parameters of the input information F1 to F3, and a mapper in the format converter 23_2 may map the parameter interpretation results of the input information F1 to F3 into the json format, so as to generate the input information F7 to F9 conforming to the json format.

Afterwards, the main control device 130 may transmit a TCP packet including the input information F7 to F9 to the slave device 120 through a TCP connection. A format converter 25_1 of the protocol conversion module 25 of the slave device 120 may convert the input information F7 to F9 conforming to the json format into input information F10 to F12 conforming to an injection data format. In this embodiment, a parser in the format converter 25_1 may determine a data format of the input information F7 to F9, so that a mapper in the format converter 25_1 may convert the input information F7 to F9 conforming to the json format into the input information F10 to F12 conforming to the injection data format. Afterwards, the control injection module 26 may input the input information F10 to F12 conforming to the injection data format to the operating system of the slave device 120, so that the slave device 120 may perform the input operation I1. In this embodiment, the slave device 120 may perform the mouse drag operation to implement applications such as file dragging.

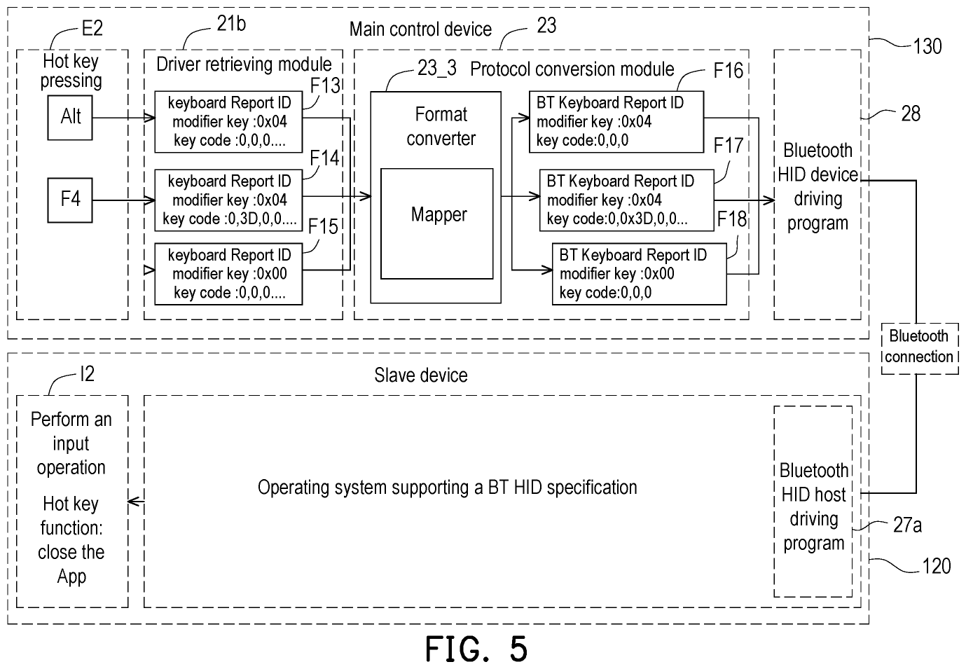

Referring to FIG. 5, in this embodiment, it is assumed that the main control device 130 runs the Windows operating system, and the slave device 120 runs the Android operating system. In addition, the main control device 130 and the slave device 120 may establish the connection through the Bluetooth transmission protocol. When the user controls the keyboard (that is, the input device 110) to perform a hot key pressing operation, a driver retrieving module 21b of the main control device 130 may intercept hot key pressing information E2 between the driving program of the input device 110 and the operating system of the main control device 130 to retrieve input information F13 to F15 of the keyboard. Here, a data format of the input information F13 to F15 conforms to the HID specification. A format converter 23_3 of the protocol conversion module 23 may convert the input information F13 to F15 into input information F16 to F18 that also conform to the HID specification. For example, the format converter 233 may convert the input information F13 to F15 conforming to a USB HID format into the input information F16 to F18 conforming to a Bluetooth HID format.

Afterwards, the protocol conversion module 23 may inject the input information F16 to F18 conforming to the HID specification into the virtual Bluetooth HID device driving program 28. The input information F16 to F18 conforming to the HID specification are packaged into the bluetooth transmission packet to be transmitted to the slave device 120. The Bluetooth HID host driving program 27a of the slave device 120 will automatically identify and process the Bluetooth transmission packet, so that the slave device 120 may perform an input operation 12. In this embodiment, the slave device 120 may perform the hot key pressing operation to achieve functions such as closing Apps.

In some embodiments, the main control device 130 may identify the slave device 120 as the control target device according to a corresponding positional relationship between a switching input operation of the input device 110 and the slave device 120. The switching input operation may include the hot key input operation or the mouse movement operation. That is, in some embodiments, the user may switch the control target device of the input device 100 by pressing the hot key or moving the mouse. In addition, the main control device 130 may determine the control target device according to a corresponding positional relationship between the main control device 130 and the slave device 120.

An application scenario of the main control device 130 and the slave device 120 as two personal electronic devices side by side is described as an example. Whenever the user presses the hot key or moves the mouse to specific screen boundaries of the main control device 130 and the slave device 120, the main control device 130 may switch the control target device from one of the main control device 130 and the slave device 120 to the other of the main control device 130 and the slave device 120. The specific screen boundaries of the main control device 130 and the slave device 120 is determined according to the corresponding positional relationship between the main control device 130 and the slave device 120. When the main control device 130 is located on a right side of the slave device 120, the specific screen boundary of the main control device 130 is a left screen boundary, and the specific screen boundary of the slave device 120 is a right screen boundary.

In some embodiments, the main control device 130 may identify the slave device 120 as the control target device according to the switching input operation of the input device 110 and a corresponding positional relationship between the slave device 120 and another slave device. That is, the main control device 130 may determine the control target device according to a corresponding positional relationship among the main control device 130, the slave device 120, and other slave devices. For example, the main control device 130, the slave device 120, and other slave devices may be arranged in an n*m array, where n and m are positive integers greater than 0. The corresponding positional relationship between the slave device 120 and the another slave device may be used to determine the control target device corresponding to the switching input operation.

In some embodiments, the corresponding positional relationship may be set and generated by the user according to actual arrangement positions of the main control device 130, the slave device 120, and other slave devices.

In some embodiments, the main control device 130 may identify the control target device as the main control device 130 or the slave device 120 according to user attention information. The user attention information is, for example, the user's line of sight information, face information, posture information, gesture information, etc. That is, the main control device 130 or the slave device 120 may be provided with a sensor, and the sensor may be configured to sense the user attention information. Therefore, the main control device 130 may identify the control target device according to the user attention information. For example, when it is determined that line of sight of the user falls on the slave device 120, the main control device 130 may identify the control target device as the slave device 120, and transmit the input information of the input device 110 to the slave device 120.

In addition, in some embodiments, multiple slave devices may be grouped into multiple groups, and the input device 110 may control the slave devices in the same group at the same time. The main control device 130 may transmit the transmission packet with the input information to the slave devices in the same group. In some embodiments, the main control device 130 may identify the slave device as the control target device according to the switching input operation of the input device 110 and the corresponding positional relationship between the slave device and the another slave device. Here, the slave device is one of first electronic devices forming a first group, and the another slave device is one of second electronic devices forming a second group. In other words, the main control device 130 may identify the control target device according to a corresponding positional relationship among the groups.

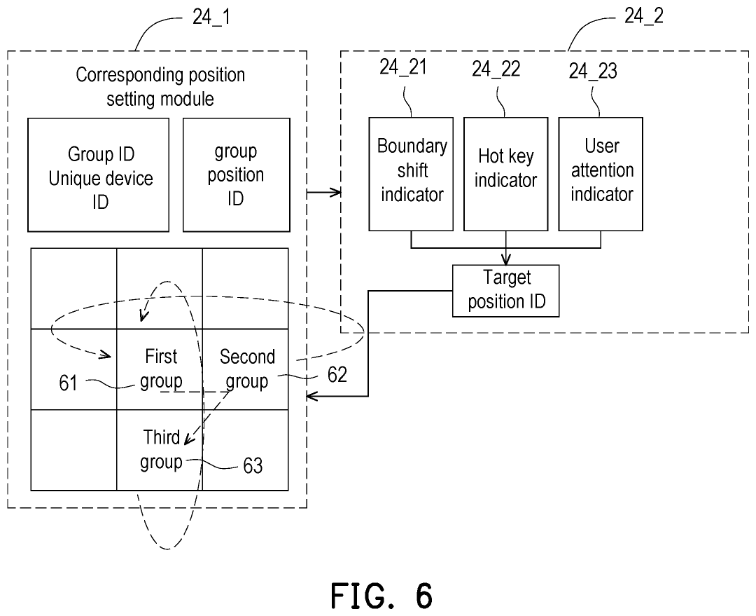

Referring to FIG. 6, the control target identification module 24 may include a corresponding position setting module 24_1 and a device designating module 24_2. The corresponding position setting module 24_1 and the device designating module 24_2 may be implemented by hardware, software, firmware, or a related combination thereof.

In this embodiment, the corresponding position setting module 24_1 is configured to set the corresponding positional relationship among the groups. The corresponding positional relationship among the groups will be used as a reference for the device designating module 24_2 to identify the control target device. Here, the groups include a first group 61, a second group 62, and a third group 63. An arrangement of the first group 61, the second group 62, and the third group 63 is shown in FIG. 6. The first group 61, the second group 62, and the third group 63 may respectively include multiple slave devices, and the slave devices may be connected to the main control device 130 through the TCP transmission protocol, for example. The corresponding position setting module 24_1 may record each of group IDs of the first group 61, the second group 62, and the third group 63, and unique device IDs of each of the slave devices. In addition, the corresponding position setting module 24_1 may record each of group position IDs corresponding to the first group 61, the second group 62, and the third group 63. The group position IDs are determined according to each of setting positions of the first group 61, the second group 62, and the third group 63.

The device designating module 24_2 may include a boundary shift indicator 24_21, a hot key indicator 24_22, and a user attention indicator 24_23. The boundary shift indicator 24_21 and the hot key indicator 24_22 may switch the control target device according to the switching input operation of the input device 110.

In some embodiments, the boundary shift indicator 24_21 may detect that the mouse is moved to the right screen boundary of the slave device in the first group 61. Thus, the boundary shift indicator 24_21 may report a target position ID corresponding to the right screen boundary of the first group 61 (i.e., the group position ID corresponding to the second group 62) to the corresponding position setting module 24_1. Therefore, the corresponding position setting module 24_1 may determine that the control target device is the slave device in the second group 62 according to the target position ID. In addition, the boundary shift indicator 24_21 may detect that the mouse is moved to an upper screen boundary of the slave device in the third group 63. Thus, the boundary shift indicator 24_21 may report the target position ID corresponding to the upper screen boundary of the third group 63 (i.e., the group position ID corresponding to the first group 61) to the corresponding position setting module 24_1. Therefore, the corresponding position setting module 24_1 may determine that the control target device is the slave device in the first group 61 according to the target position ID.

In addition, in some embodiments, when the boundary shift indicator 24_21 detects that the mouse is moved to the right screen boundary of the slave device in the second group 62, the boundary shift indicator 24_21 may report the target position ID corresponding to the right screen boundary of the second group 62 (i.e., the group position ID corresponding to the first group 61) to the corresponding position setting module 24_1. Therefore, the corresponding position setting module 24_1 may determine the control target device as the slave device in the first group 61 according to the target position ID, so as to switch the control target device from the second group 62 to the first group 61. In addition, when the boundary shift indicator 24_21 detects that the mouse is moved to a lower screen boundary of the slave device in the third group 63, the boundary shift indicator 24_21 may report the target position ID corresponding to the lower screen boundary of the third group 63 (i.e., the group position ID corresponding to the first group 61) to the corresponding position setting module 24_1. Therefore, the corresponding position setting module 24_1 may determine the control target device as the slave device in the first group 61 according to the target position ID, so as to switch the control target device from the third group 63 to the first group 61.

In some embodiments, the hot key indicator 24_22 may detect hot key pressing on the keyboard. In some embodiments, the first group 61, the second group 62, and the third group 63 may respectively correspond to different hot keys. When the hot key indicator 24_22 detects that the hot key corresponding to the first group 61 is pressed, the hot key indicator 24_22 may report the target position ID (i.e., the group position ID corresponding to the first group 61) to the corresponding position setting module 24_1. Therefore, the corresponding position setting module 24_1 may determine that the control target device is the slave device in the first group 61 according to the target position ID.

In some embodiments, the user may switch the control target device to the first group 61, the second group 62, or the third group 63 by pressing a specific hot key. When the hot key indicator 24_22 detects that the specific hot key is pressed, the hot key indicator 24_22 may report the target position ID to the corresponding position setting module 24_1 according to the corresponding positional relationship or the group IDs of the first group 6, the second group 62, and the third group 63. Therefore, the corresponding position setting module 24_1 may confirm the control target device according to the target position ID.

For example, when the hot key indicator 24_22 detects that the specific hot key is pressed, the hot key indicator 24_22 may switch the control target device according to a sequence of the group IDs. Specifically, the control target device may be cyclically switched to the first group 61, the second group 62, or the third group 63 in sequence. In this way, in response to the specific hot key being pressed, the control target device may be switched from the first group 61 to the second group 62. In response to the specific hot key being pressed, the control target device may be switched from the second group 62 to the third group 63. In response to the specific hot key being pressed, the control target device may be switched from the third group 63 to the first group 61.

In addition, when the hot key indicator 24_22 detects that the specific hot key is pressed, the hot key indicator 24_22 may switch the control target device according to the corresponding positional relationship among the first group 61, the second group 62, and the third group 63. For example, in response to the specific hot key in up and down directions being pressed, the control target device may be repeatedly switched to the first group 61 or the second group 62. In response to the specific hot key in left and right directions being pressed, the control target device may be repeatedly switched to the first group 61 or the third group 63.

In some embodiments, the user attention indicator 24_23 may detect the user attention information, such as the line of sight information. For example, the user attention indicator 24_23 may obtain a point of the line of sight according to the line of sight information of the user, and determine the control target device according to a position of the point of the line of sight. That is, the user attention indicator 24_23 may report the target position ID to the corresponding position setting module 24_1 according to the position of the point of the line of sight. Therefore, the corresponding position setting module 24_1 may confirm the control target device that the user is looking at according to the target position ID.

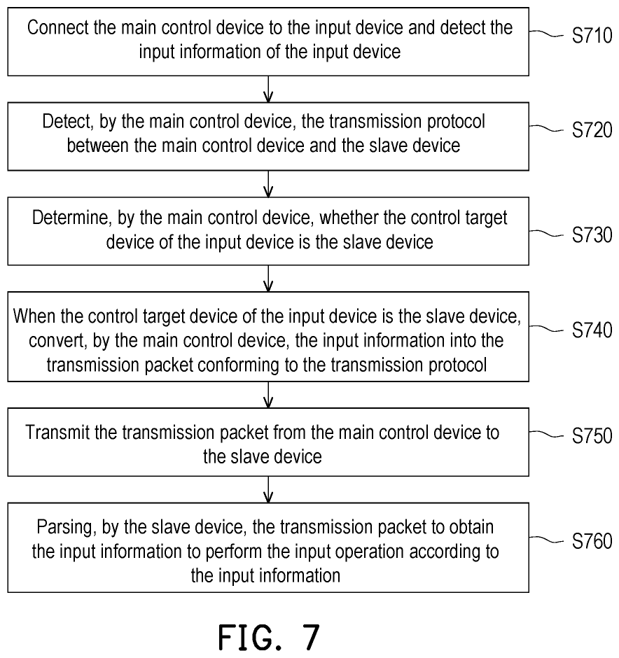

FIG. 7 is a flowchart of a method for switching an input device according to an embodiment of the disclosure. The method is adapted to the system 10 for switching an input device shown in FIG. 1. In step S710, the main control device 130 is connected to the input device 110 and detects the input information of the input device 110. In step S720, the main control device 130 detects the transmission protocol between the main control device 130 and the slave device 120. In step S730, the main control device 130 determines whether the control target device of the input device 110 is the slave device 120. In step S740, when the control target device of the input device 110 is the slave device 120, the main control device 130 converts the input information into the transmission packet conforming to the transmission protocol. In step S750, the main control device 130 transmits the transmission packet to the slave device 120. In step S760, the slave device 120 parses the transmission packet to obtain the input information, so as to perform the input operation according to the input information. Implementations and details of the steps S710 to S760 have been described in detail in the embodiments of FIGS. 1 to 6. Therefore, the same details will not be repeated in the following.

Based on the above, in the embodiment of the disclosure, the main control device may convert the input information of the input device into the transmission packet according to the transmission protocol supported by the slave device, and transmit the transmission packet through the connection between the main control device and the slave device. In response to whether the transmission protocol supported by the slave device conforms to the general specification, the slave device may directly use the transmission packet to perform the input operation or convert the data format of the transmission packet before performing the input operation. Therefore, even if the main control device and the slave device are the computer devices with different operating system platforms, cross-platform and cross-device control functions may still be achieved. In addition, in the disclosure, the cross-device control function may be achieved without using the input device that supports multiple communication channels. As a result, the disclosure not only enhances the convenience and freedom of the cross-device control function of the input device, but is not limited by compatibility of the software and hardware of the main control device, slave device, or input device.

What is claimed is:

1. A method for switching an input device adapted to a system for switching the input device comprising a main control device and a slave device, wherein the method comprises:
connecting the main control device to the input device and detecting input information of the input device;
detecting, by the main control device, a transmission protocol between the main control device and the slave device;
determining, by the main control device, whether a control target device of the input device is the slave device;
when the control target device of the input device is the slave device, converting, by the main control device, the input information into a transmission packet conforming to the transmission protocol;
transmitting the transmission packet from the main control device to the slave device; and
parsing, by the slave device, the transmission packet to obtain the input information to perform an input operation according to the input information.

2. The method for switching the input device according to claim 1, wherein connecting the main control device to the input device and detecting the input information of the input device comprises:
retrieving, by the main control device, an input event of the input device by using a system event hook program, wherein the input event comprises the input information.

3. The method for switching the input device according to claim 1, wherein connecting the main control device to the input device and detecting the input information of the input device comprises:
retrieving, by the main control device, the input information of the input device through a driving program.

4. The method for switching the input device according to claim 1, wherein when the control target device of the input device is the slave device, converting, by the main control device, the input information into the transmission packet conforming to the transmission protocol comprises:
when the transmission protocol conforms to a general specification, converting, by the main control device, the input information into a data format conforming to the general specification to generate the transmission packet; and
inputting, by the main control device, the transmission packet to a driving program supporting the general specification.

5. The method for switching the input device according to claim 4, wherein parsing, by the slave device, the transmission packet to obtain the input information to perform the input operation according to the input information comprises:
obtaining, by the slave device, the transmission packet according to another driving program, and performing the input operation according to the input information conforming to the general specification in the transmission packet.

6. The method for switching the input device according to claim 1, wherein when the control target device of the input device is the slave device, converting, by the main control device, the input information into the transmission packet conforming to the transmission protocol comprises:
converting, by the main control device, the input information conforming to a first data format into the input information conforming to a second data format to generate the transmission packet conforming to the transmission protocol.

7. The method for switching the input device according to claim 6, wherein parsing, by the slave device, the transmission packet to obtain the input information to perform the input operation according to the input information comprises:
converting, by the slave device, the input information conforming to the second data format into the input information conforming to a third data format, and performing the input operation according to the input information conforming to the third data format.

8. The method for switching the input device according to claim 1, wherein determining, by the main control device, whether the control target device of the input device is the slave device comprises:
identifying, by the main control device, the slave device as the control target device according to a corresponding positional relationship between a switching input operation of the input device and the slave device.

9. The method for switching the input device according to claim 8, wherein identifying, by the main control device, the slave device as the control target device according to the corresponding positional relationship between the switching input operation of the input device and the slave device comprises:
identifying, by the main control device, the slave device as the control target device according to the switching input operation of the input device and the corresponding positional relationship between the slave device and another slave device,
wherein the slave device is one of a plurality of first electronic devices forming a first group, and the another slave device is one of a plurality of second electronic devices forming a second group.

10. The method for switching the input device according to claim 1, wherein determining, by the main control device, whether the control target device of the input device is the slave device comprises:
identifying, by the main control device, the control target device of the input device according to user attention information.

11. A system for switching an input device, comprising:
an input device;
a slave device; and
a main control device, connected to the input device and detecting input information of the input device, detecting a transmission protocol between the main control device and the slave device, and determining whether a control target device of the input device is the slave device,
wherein when the control target device of the input device is the slave device, the main control device converts the input information into a transmission packet conforming to the transmission protocol, and transmits the transmission packet to the slave device,
the slave device parses the transmission packet to obtain the input information to perform an input operation according to the input information.

12. The system for switching the input device according to claim 11, wherein the main control device retrieves an input event of the input device by using a system event hook program, wherein the input event comprises the input information.

13. The system for switching the input device according to claim 11, wherein the main control device retrieves the input information of the input device through a driving program.

14. The system for switching the input device according to claim 11, wherein the transmission protocol conforms to a general specification, and the main control device converts the input information into a data format conforming to the general specification to generate the transmission packet, and inputs the transmission packet to a driving program supporting the general specification.

15. The system for switching the input device according to claim 14, wherein the slave device obtains the transmission packet according to another driving program, and performs the input operation according to the input information conforming to the general specification in the transmission packet.

16. The system for switching the input device according to claim 11, wherein the main control device converts the input information conforming to a first data format into the input information conforming to a second data format to generate the transmission packet conforming to the transmission protocol.

17. The system for switching the input device according to claim 16, wherein the slave device converts the input information conforming to the second data format into the input information conforming to a third data format, and performs the input operation according to the input information conforming to the third data format.

18. The system for switching the input device according to claim 11, wherein the main control device identifies the slave device as the control target device according to a corresponding positional relationship between a switching input operation of the input device and the slave device.

19. The system for switching the input device according to claim 18, wherein the main control device identifies the slave device as the control target device according to the switching input operation of the input device and the corresponding positional relationship between the slave device and another slave device,
wherein the slave device is one of a plurality of first electronic devices forming a first group, and the another slave device is one of a plurality of second electronic devices forming a second group.

20. The system for switching the input device according to claim 11, wherein the main control device identifies the control target device according to user attention information.
